(19) United States
(12) Patent Application Publication
(10) Pub. No.: US 2023/0105483 A1
(43) Pub. Date: Apr. 6, 2023

(54) SYSTEMS AND METHODS OF FACILITATING DIGITAL RATINGS AND SECURED SALES OF DIGITAL WORKS OF ART

(71) Applicants: Danny Rittman, Oceanside, CA (US); Mo Jacob, Beverly Hills, CA (US)

(72) Inventors: Danny Rittman, Oceanside, CA (US); Mo Jacob, Beverly Hills, CA (US)

(21) Appl. No.: 18/072,739

(22) Filed: Dec. 1, 2022

Related U.S. Application Data
(63) Continuation-in-part of application No. 17/883,658, filed on Aug. 9, 2022.
Application No. 17/883,658 is a continuation-in-part of application No. 17/542,690, filed on Dec. 6, 2021.
(60) Provisional application No. 63/246,952, filed on Sep. 22, 2021.

(51) Int. Cl. G06Q 30/08; H04L 9/32

(52) U.S. Cl. CPC G06Q 30/08; H04L 9/3213; H04L 2209/60

(57) ABSTRACT

Blockchain systems and methods for digital ratings and secured sales of digital works of art are provided. The systems include a platform for posting art, an interface, an auction module, and an artificial intelligence unit. The platform enables artists to post digital works of art on their personal pages. The interface enables users to become followers of the digital works of art and post likes or dislikes for the digital works of art, and the platform assigns a monetary value to the like. Each digital work of art is assigned a purchase price equal to the monetary value assigned to the like multiplied by the number of likes for the first digital work of art. When a user offers the purchase price the auction module transfers payment to the first artist and the first work of art to the user. The interface includes an opinionated share button, which may comprise a combination like-share button and a combination dislike-share button.

### CROSS-REFERENCE TO RELATED APPLICATIONS

This application is a continuation-in-part of and claims priority to U.S. patent application Ser. No. 17/883,658, filed Aug. 9, 2022, which is a continuation-in-part of and claims priority to U.S. patent application Ser. No. 17/542,690, filed Dec. 6, 2021, which is a non-provisional of and claims priority to U.S. patent application Ser. No. 63/246,952, filed Sep. 22, 2021, each of which is hereby incorporated by reference herein in its entirety.

### FIELD

The present disclosure relates to digital auction systems, systems and methods of digital ratings and secured sales of digital works of art, and platforms for secure auctions of digital works of art.

### BACKGROUND

Auction houses for artwork have existed for many years. They handle authenticating works of art and specialize in their purchase and sale. However, an increasing proportion of art is not tangible, but instead created and circulated digitally. One example is the non-fungible token (NFT). NFTs can be anything downloaded (drawings, music, etc.) but are most commonly digital works of art. An NFT is unique and non-interchangeable and stored on a digital ledger using blockchain technology.

Accordingly, there is a need for systems and methods facilitating the secure purchase and sale of digital works of art. There is a need for an online platform for auction of digital works of art. There is also a need for online systems and methods including blockchain technology and NFT support for digital artists.

### SUMMARY

The present disclosure, in its many embodiments, alleviates to a great extent the disadvantages of known auction platforms for works of art by providing systems and methods of digital ratings and secured sales of digital works of art and platforms for secure auctions of digital works of art. An artist can post his or her digital artwork on disclosed platforms and other users can express likes. The artist can get an extremely high value for his or her artwork via the likes. Other users can purchase the artwork, re-post it, and increase the value of the artwork via additional likes. The system includes blockchain technology and NFT support.

An object of embodiments of the present disclosure is to enable members of the system to get exposure and earn a living by virtue of their artistic creations. The original artist, and indeed anyone, can develop a reputation and become famous. The next Da Vinci or Picasso may be a digital artist. Other objects of the disclosure are to provide an open system and fun application for free auctions of personal artwork.

Exemplary embodiments of a computer-implemented blockchain system for digital ratings and secured sales of digital works of art comprise a platform for posting art, an interface, an auction module, and an artificial intelligence unit. The platform enables a first artist to post a first digital work of art on the first artist's personal page. The interface enables users to become followers of the first digital work of art and post a like or a dislike for the first digital work of art, and the platform assigns a monetary value to the like. The auction module enables users to bid on the first digital work of art. The artificial intelligence unit learns features of the first digital work of art and provides an alert if unauthorized copying of the first digital work of art is detected.

The first digital work of art is assigned a purchase price equal to the monetary value assigned to the like multiplied by a number of likes for the first digital work of art. When a user offers the purchase price the auction module transfers payment to the first artist and the first work of art to the user. In exemplary embodiments, the first artist receives a majority percentage of the purchase price and the system deducts a minority percentage of the purchase price. All payments may be stored in a blockchain.

In exemplary embodiments, the works of art can be purchased via tokens that can be redeemed for cash. The works of art also can be purchased via likes. In exemplary embodiments, the first artist can redeem the likes posted for the first digital work of art to purchase a second digital work of art owned by a user or a second artist. A user who purchases the first digital work of art can redeem the likes posted for the first digital work of art to purchase a second digital work of art owned by another user or the first artist or a second artist. When the user purchases the first digital work of art it is transferred from the first artist's personal page to the user's personal page. In exemplary embodiments, with sale of the first digital work of art the followers and likes associated with the first digital work of art are transferred from the first artist's personal page to the user's personal page. If a digital work of art receives a pre-determined number of likes it may be transformed into a non-fungible token.

Artwork posted in disclosed systems may include some nudes or other controversial content that are considered art, and the system will offer some leniency, but exemplary public censure systems will enable efficient methods to eliminate offensive or inappropriate materials posted by users. Exemplary embodiments comprise a public censure system enabling deletion of the first digital work of art if the first digital work of art is determined to be offensive or inappropriate based on a pre-determined percentage of dislikes posted. The pre-determined percentage may be two percent of viewers of the first digital work of art. An artificial intelligence unit is in communication with the platform, the auction module, and the public censure system. In exemplary embodiments, the artificial intelligence unit learns features of the first digital work of art and monitors for dislikes.

In exemplary embodiments, the public censure system comprises a supervisory system. If a dislike is posted for the first digital work of art, the supervisory system automatically monitors the first digital work of art and user comments related thereto. If an inappropriate or offensive comment is detected, the supervisory system removes the inappropriate or offensive comment. In exemplary embodiments, the public censure system performs natural language processing techniques and text classification processes to identify inappropriate or offensive content. In exemplary embodiments, the public censure system comprises a convolutional neural network performing semantic image segmentation to identify inappropriate or offensive content.

An exemplary embodiment of a computer-implemented blockchain method of digitally rating and securely selling digital works of art comprises facilitating posting of a first digital work of art on a first artist's personal page, enabling users to become followers of the first digital work of art and post a like or a dislike for the first digital work of art, and assigning a monetary value to the like. Disclosed methods further comprise generating digital tokens that can be used to purchase the first digital work of art and can be redeemed for cash, providing an auction whereby users can bid on the first digital work of art, and identifying users and providing access to the auction based on biometric or facial features of the users.

The methods include assigning the first digital work of art a purchase price equal to the monetary value assigned to the like multiplied by a number of likes for the first digital work of art, transferring payment to the first artist and transferring the first work of art to a user when the user offers the purchase price to the first artist, storing all payments in a blockchain, and continuously monitoring for security breaches and blocking any detected security breach.

In exemplary methods, works of art can be purchased via likes. The first artist can redeem the likes posted for the first digital work of art to purchase a second digital work of art owned by a user or a second artist. When a user purchases the first digital work of art, followers associated with the first digital work of art and likes associated with the first digital work of art are transferred from the first artist's personal page to the user's personal page. In exemplary embodiments, if a digital work of art receives a pre-determined number of likes it is transformed into a non-fungible token.

Exemplary methods comprise monitoring for and identifying inappropriate or offensive content in the first digital work of art and user comments related thereto and deleting any inappropriate or offensive content identified. The identifying step may comprise performing image processing including pattern recognition to distinguish and classify objects in an image, and the image processing may comprise capturing an image and performing morphological processing on the image to determine shapes and structures of objects within the image. The first digital work of art is determined to be inappropriate or offensive if it receives a pre-determined percentage of dislikes posted.

Exemplary methods further comprise automatically monitoring the first digital work of art and user comments related thereto if a dislike is posted for the first digital work of art. Any inappropriate or offensive comment detected will be removed or deleted. Exemplary methods include performing natural language processing techniques and text classification processes to identify inappropriate or offensive content. Exemplary methods include performing semantic image segmentation to identify inappropriate or offensive content.

Exemplary embodiments of a digital auction system using blockchain-secured digital tokens comprise a platform for posting artwork, an interface, an auction module, and an artificial intelligence unit. The platform enables a first artist to post a first digital work of art on the first artist's personal page. The interface enables users to become followers of the first digital work of art and post a like for the first digital work of art, and the platform assigns a monetary value to the like. The auction module enables users to bid on the first digital work of art, and the artificial intelligence unit learns features of the first digital work of art.

In exemplary embodiments, the first digital work of art is assigned a purchase price equal to the monetary value assigned to the like multiplied by a number of likes for the first digital work of art. When a user offers the purchase price the auction module transfers payment to the first artist and the first work of art to the user. Payments may be stored in a blockchain. Works of art can be purchased via likes or via digital tokens that can be redeemed for cash. When a user purchases the first digital work of art, followers associated with the first work of art and likes associated with the first digital work of art are transferred from the first artist's personal page to the user's personal page.

In exemplary embodiments, the first artist can redeem the likes posted for the first digital work of art to purchase a second digital work of art owned by a user or a second artist. A user who purchases the first digital work of art can redeem the likes posted for the first digital work of art to purchase a second digital work of art owned by another user or the first artist or a second artist. In exemplary embodiments, if a digital work of art receives a pre-determined number of likes it is transformed into a non-fungible token.

In exemplary embodiments, the artificial intelligence unit is configured to provide an alert if unauthorized copying of the first digital work of art is detected, launch a marketing campaign according to the features and genre of the first digital work of art, issue a rating for parental control, and/or create a different genre variation of the first digital work of art. Exemplary systems are developed as a mobile application and a web application.

In exemplary auction systems, an artificial intelligence unit is in communication with the platform, the auction module, and the public censure system, the artificial intelligence unit learning features of the first digital work of art and monitoring for dislikes. A public censure system including a supervisory system may be provided. The public censure system enables deletion of the first digital work of art if the first digital work of art is determined to be offensive or inappropriate based on a pre-determined percentage of dislikes posted. If a dislike is posted for the first digital work of art, the supervisory system automatically monitors the first digital work of art and user comments related thereto. If an inappropriate or offensive comment is detected, the supervisory system removes the inappropriate or offensive comment.

In exemplary embodiments, the interface includes an opinionated share button. The opinionated share button may comprise a combination like-share button and a combination dislike-share button. The combination like-share button may include a thumb's up icon, and the combination dislike-share button may include a thumb's down icon. In exemplary embodiments, the combination like-share button comprises a thumb's up icon and a share icon inside the thumb's up icon, and the combination dislike-share button comprises a thumb's down icon and a share icon inside the thumb's down icon.

Accordingly, it is seen that digital auction systems and systems and methods of digitally rating and securely selling digital works of art are provided. These and other features of the disclosed embodiments will be appreciated from review of the following detailed description, along with the accompanying figures in which like reference numbers refer to like parts throughout.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is a front view of an exemplary embodiment of a computer-implemented blockchain system and method of digital ratings and secured sales of digital works of art in accordance with the present disclosure;

FIG. 2 is a front view of an exemplary embodiment of a computer-implemented blockchain system and method of digital ratings and secured sales of digital works of art in accordance with the present disclosure;

FIG. 3 is a front view of an exemplary embodiment of a digital auction system and computer-implemented blockchain system and method of digital ratings and secured sales of digital works of art in accordance with the present disclosure;

FIG. 4 is a front view of an exemplary embodiment of a computer-implemented blockchain system and method of digital ratings and secured sales of digital works of art in accordance with the present disclosure;

FIG. 5 is a front view of an exemplary embodiment of a computer-implemented blockchain system and method of digital ratings and secured sales of digital works of art in accordance with the present disclosure;

FIG. 6 is a front view of an exemplary embodiment of a digital auction system and computer-implemented blockchain system and method of digital ratings and secured sales of digital works of art in accordance with the present disclosure;

FIG. 7 is a front view of an exemplary embodiment of a digital auction system and computer-implemented blockchain system and method of digital ratings and secured sales of digital works of art in accordance with the present disclosure;

FIG. 8 is a block diagram of an exemplary embodiment of a digital auction system and computer-implemented blockchain system and method of digital ratings and secured sales of digital works of art in accordance with the present disclosure;

FIG. 9 is a block diagram of an exemplary embodiment of a digital auction system and computer-implemented blockchain system and method of digital ratings and secured sales of digital works of art in accordance with the present disclosure;

FIG. 10 is a block diagram of an exemplary embodiment of an artificial intelligence unit used in a digital auction system and computer-implemented blockchain system and method of digital ratings and secured sales of digital works of art in accordance with the present disclosure;

FIG. 11 is a process flow diagram of an exemplary supervised learning approach of an artificial intelligence unit in accordance with the present disclosure;

FIG. 12 is a process flow diagram of an exemplary unsupervised learning approach of an artificial intelligence unit in accordance with the present disclosure;

FIG. 13 is a block diagram of an exemplary Group Key Management (GKM) approach in accordance with the present disclosure;

FIG. 14 is a process flow diagram of an exemplary copyright detection system in accordance with the present disclosure;

FIG. 15 is a front view of an exemplary sign-up page of a digital auction system and computer-implemented blockchain system and method of digital ratings and secured sales of digital works of art in accordance with the present disclosure;

FIG. 16 is a front view of an exemplary login page of a digital auction system and computer-implemented blockchain system and method of digital ratings and secured sales of digital works of art in accordance with the present disclosure;

FIG. 17 is a front view of an exemplary settings page of a digital auction system and computer-implemented blockchain system and method of digital ratings and secured sales of digital works of art in accordance with the present disclosure;

FIG. 18 is a front view of an exemplary activity page of a digital auction system and computer-implemented blockchain system and method of digital ratings and secured sales of digital works of art in accordance with the present disclosure;

FIG. 19 is a front view of an exemplary following page of a digital auction system and computer-implemented blockchain system and method of digital ratings and secured sales of digital works of art in accordance with the present disclosure;

FIG. 20 is a block diagram showing an exemplary embodiment of the internal structure of a computer in which various embodiments of the disclosure may be implemented;

FIG. 21 is a perspective view of an exemplary embodiment of image processing in accordance with the present disclosure;

FIG. 22 is a perspective view of an exemplary embodiment of image processing in accordance with the present disclosure;

FIG. 23 is a process flow diagram of an exemplary embodiment of a public censure system including image processing in accordance with the present disclosure;

FIG. 24 is a front view of an exemplary embodiment of a public censure system in accordance with the present disclosure;

FIG. 25 is a front view of an exemplary embodiment of a public censure system in accordance with the present disclosure;

FIG. 26 is a schematic of an exemplary embodiment of semantic image segmentation in accordance with the present disclosure;

FIG. 27 is a front view of exemplary embodiments of opinionated share buttons in accordance with the present disclosure; and

FIG. 28 is a front view of an exemplary embodiment of a computer-implemented blockchain system and method of digital ratings and secured sales of digital works of art showing exemplary opinionated share buttons in accordance with the present disclosure.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure.

As used herein, the “present disclosure” refers to any one of the embodiments described herein, and any equivalents. Furthermore, reference to various aspects of the disclosure throughout this document does not mean that all claimed embodiments or methods must include the referenced aspects. Reference to materials, configurations, directions, and other parameters should be considered as representative and illustrative of the capabilities of exemplary embodiments, and embodiments can operate within a wide variety of such parameters. It should be noted that the figures do not show every piece of equipment, nor the materials, configurations, and directions of the various circuits and communications systems.

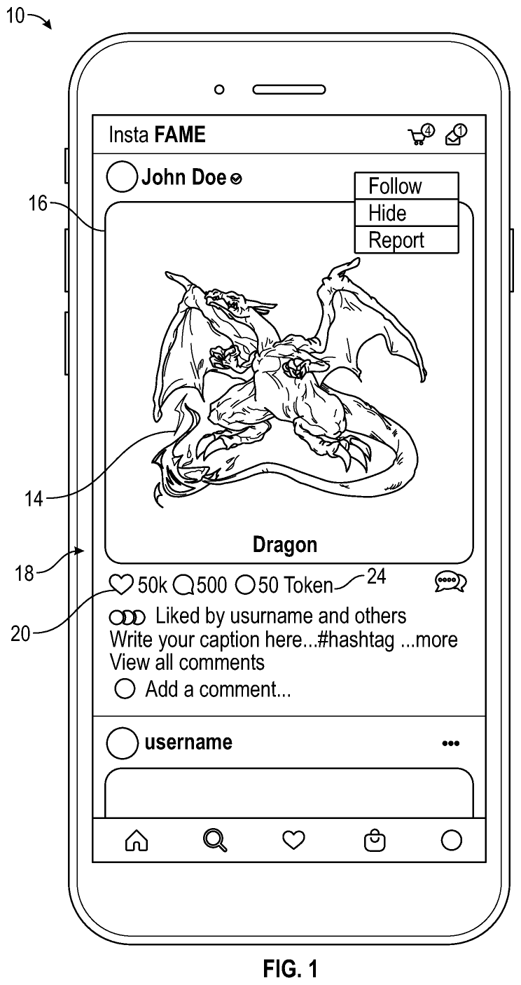

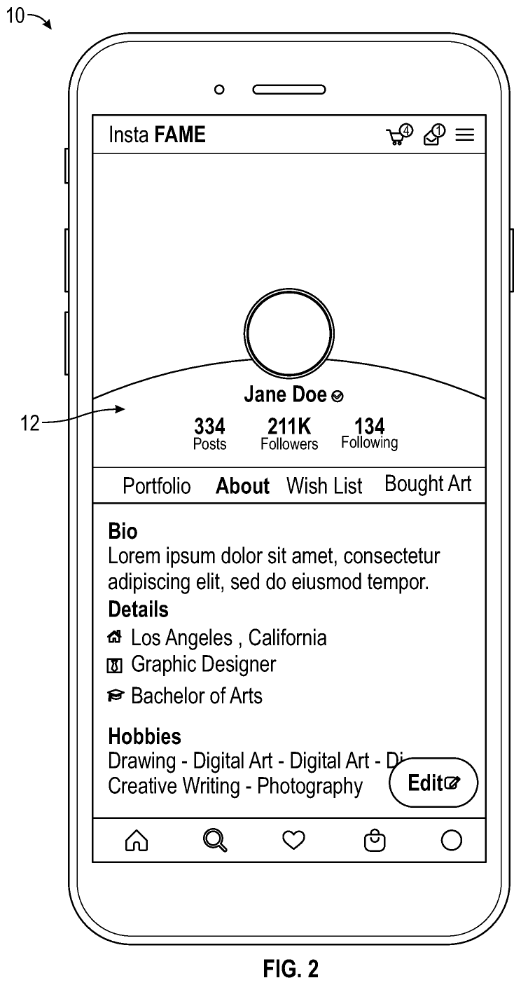

An exemplary embodiment of a blockchain system 1 for digital ratings and secured sales of digital works of art is illustrated in FIGS. 1-6. A platform 10 is provided to users via an internet application and/or a mobile application. The platform 10 provides individuals with personal pages 12 and enables anyone to create and upload any digital work of art 14 that they want to post or display on their personal page. A user may enter details such as bio, geographical location, and hobbies on their personal pages 12. The term “art” or “work of art” is defined as broadly as possible, and could include but is not limited to, drawings, paintings, photographs, lithographs, videos, etc. The creative user's or artist's posts 16 consist of originally created digital images and/or videos.

The system 1 also provides a graphical user interface 18 so users can “like” other users' artwork posts. Thus, users can post likes 20 tied to the artwork posts 16 of the creative/artist users. The users posting likes 20 may be other creative/artist users or users who are not creating their own works of art. Through the system interface 18, users can become followers of creative/artist users and/or followers of posted digital works of art 14. A user that appreciates a particular digital work of art 14 can post a like 20 for it. In exemplary embodiments, the platform 10 assigns a monetary value to each like 20. As discussed in more detail herein, the monetary value of a like of a particular work of art can form the foundation for assigning a purchase price to that work of art 14.

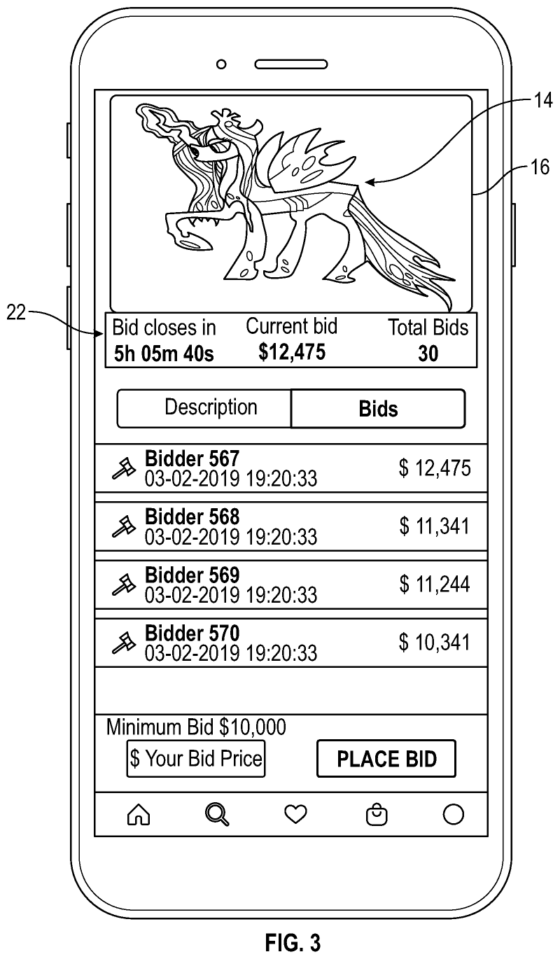

Referring to FIG. 3, the system 1 includes an auction module 22 providing auction functionality. The digital auction system 22 enables users to bid on a posted digital work of art 14. The digital auction system 22 may display the current high bid, the total number of bids, the bid associated with each participating bidder, and the time remaining in the digital auction. In exemplary embodiments, every post 16 with a work of art 14 is an open auction. Alternatively, a creative/artist user may choose whether to offer his or her digital work of art 14 for sale. In either case, the auction module 22 assigns a purchase price 24 to the work of art 14. A user that is so inclined may buy another user's posted work of art 14 for the purchase price 24 determined by the auction system 22.

The value of a posted work of art 14 is determined by the minimum value the user posts originally or the number of likes 20 viewers provide in connection with the posted work of art. In one pricing mechanism, the purchase price 24 for a work of art 14 would be the product of the monetary value assigned to each like 20 for that work of art 14 multiplied by the number of likes 20 posted for the work of art 14. For instance, if the currency value for a like 20 of a particular posted work of art 14 is $1.00 and the post has 100 likes, then the purchase price would be $100. In another example, a user or artist posts a work of art 14 for two (2) tokens, but the work of art gains four (4) likes 20, so the value or purchase price for the work of art 14 is four (4) tokens. If the number of likes 20 is only one (1), then the purchase price of the work of art would be the minimum posted, i.e., two (2) tokens. This type of pricing calculation can be expressed by the following logical formula: If #ofLIKES >=minimumTokenAskedBySeller, then picturePRICE==#ofLIKES; Else picturePRICE==minimumTokenAskedBySeller; End if.

The first user willing to pay the purchase price for a work of art 14 becomes the new owner of the artwork post. More particularly, if a user offers the purchase price to the owner of the artwork post, the auction module 22 transfers payment to the owner and transfers the posted work of art 14 to the buyer-user. The administrator or owner of the system 1 may deduct a handling fee from each transaction.

An exemplary accounting process would function as follows. When a work of art 14 is sold the first time, the original artist receives 90% of the purchase price, and 10% is deducted. From that 10%, the original artist received 5% and the system administrator takes a fee of 5%, only on the first sale. From that point on, if the first buyer of the work of art 14 sells it, he or she receives 90% of the purchase price, the original artist receives 5%, and the system administrator takes a fee of 5%.

For example, an artist sells her work of art 14 to a first buyer for an initial price of two (2) tokens. 10% (0.2 tokens) is deducted and is shared half/half between the system administrator and the original artist/seller, i.e., 0.1 tokens to the system administrator and 0.1 tokens to the original artist/seller. Thus, for her sale the original artist/seller receives 1.9 tokens, i.e., 2−0.2+0.1 tokens. The system administrator receives 0.1 tokens. If the first buyer then sells the work of art 14 to a second buyer, the first buyer will receive 90% of the purchase price, and 10% will be deducted and split between the system administrator and the original artist/seller. This type of accounting calculation can be expressed by the following logical formula: originalSellerCreatorFee=sellingPrice−10%*sellingPrice+10%*sellingPrice*½; instantFAMECorpFee=10%*sellingPrice*½; Once someone buys the post further: postBuyerFee=sellingPrice−10%*sellingPrice; instantFAMECorpFee=10%*sellingPrice*½; originalSellerCreatorFee=10%*sellingPrice*½.

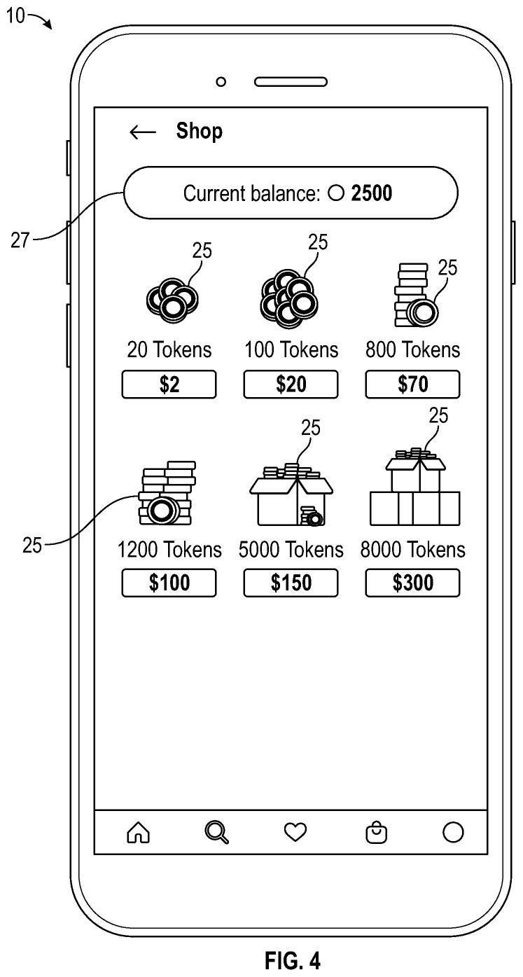

In exemplary embodiments, these transactions are done via points/tokens which can be purchased and redeemed for cash. The platform enables users to enter their credit card information and buy points/tokens 25 to use to purchase art. Also, likes 20 from various works of art 14 owned by the user can be redeemed for tokens to be used to buy additional works of art 14. For example, if a user wants to buy a new work of art 14 having a purchase price of $100, she could monetize likes 20 accumulated for other works of art 14 she has posted. If one of her posted works of art 14 has received 75 likes and another has received 25 likes, the platform allows her to pool and redeem those 100 likes and use them toward her purchase of the new work of art 14. In exemplary embodiments, the platform 10 includes a current balance page 27 so the user can easily see how many tokens she has. An exemplary current balance page 27 is shown in FIG. 4.

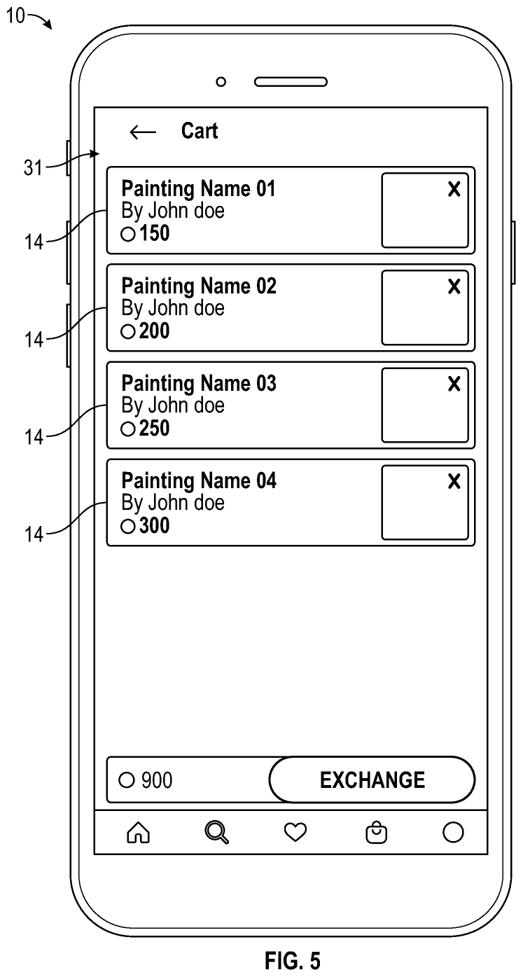

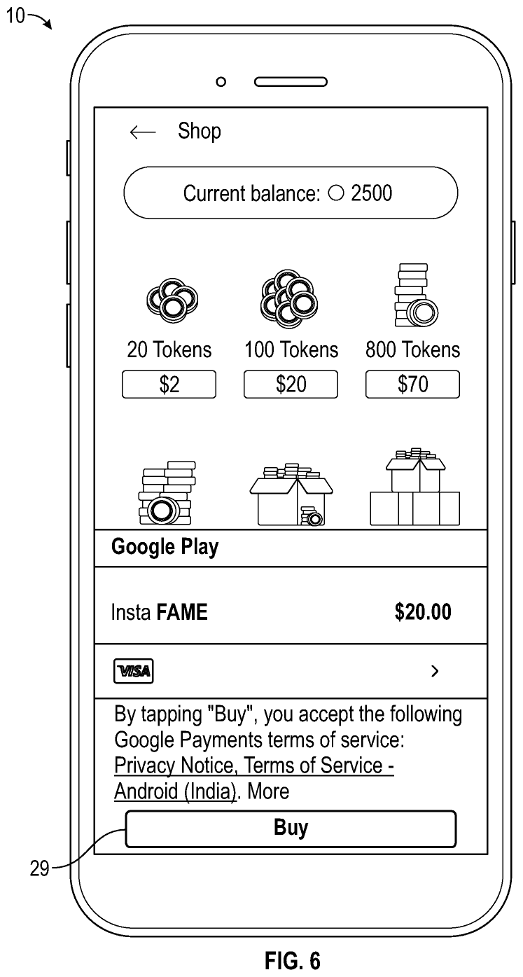

Turning to FIGS. 5 and 6, via the graphical user interface 18 the buyer-user can place the works of art 14 he wants to buy in her cart 31. Then the buyer-user can click the “Buy” button 29 on the platform. He or she then becomes the new owner of the work of art 14 and all the likes 20 associated with the posted work of art 14. Once a posted work of art 14 is purchased, they system 1 removes it from the original creator post (or current owner post) and places it into the buyer-user's personal page together with all the likes 20 that work of art 14 received and all the followers who liked that work of art. In other words, by acquiring a work of art 14, a user gets not only the work of art itself, but all of its followers as well. The buyer can re-purpose the purchased work of art as another one of his posts. The work of art 14 will, at the very least, keep its original value. It also has the potential to accumulate more likes 20 on the buyer's page, which would increase its value.

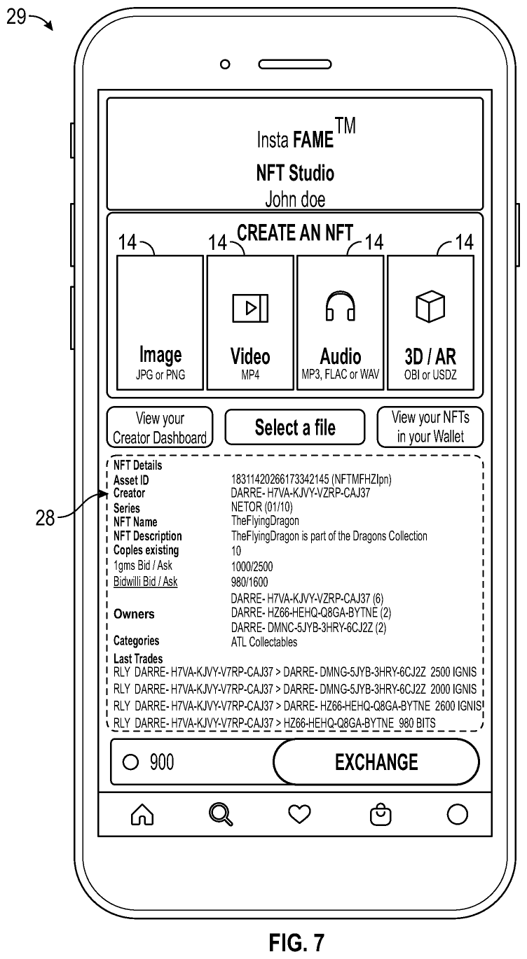

That work of art 14 can be sold again by the new owner (buyer-user), and in exemplary embodiments the original artist (creative/artist user) receives a royalty payment for every subsequent sale of his or her work of art 14. The royalty would be a reasonable market rate, e.g., up to about 15% or 20%, and will typically be 10%. In exemplary embodiments, a work of art 14 that receives a certain number of pre-detrainment likes 20, e.g., one million, is transformed by the system, or transformable by the user who owns the work, into a non-fungible token (NFT) 28. An exemplary NFT Studio page 29 is illustrated in FIG. 7. Once so transformed, the work of art 14 can be offered for sale as an NFT 28. This would be regardless of whether the original work of art 14 was purchased by anyone.

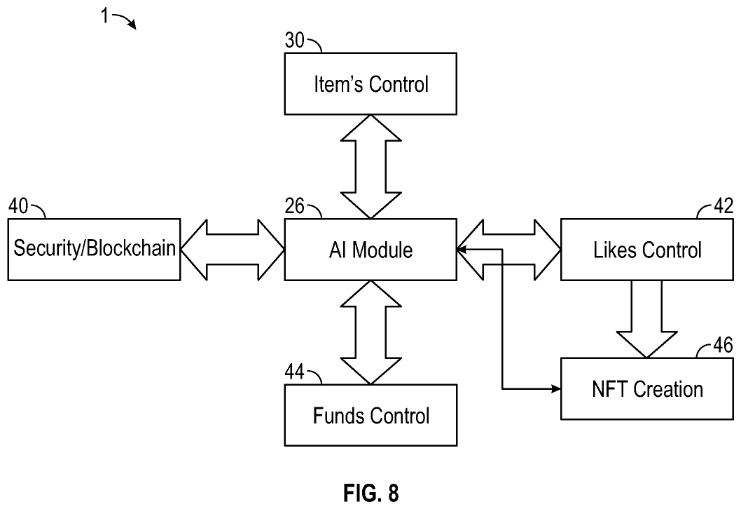

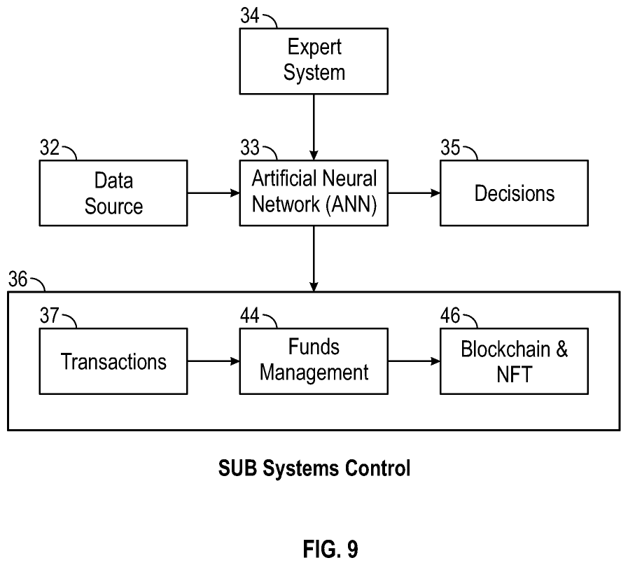

As shown in FIGS. 8 and 9, the system 1 is operated and maintained by key control units in communication with each other. Exemplary functionalities of these control units are discussed in more detail herein. An Item Control Unit 30 controls the work of art and is in communication with an Artificial Intelligence (AI) Unit 26. Blockchain 40 is in communication with the AI unit 26 and provides several important security features. There are units for Likes Control 42 and Funds Control 44. There is also an NFT Creation Unit 46. As discussed in more detail herein, the AI Unit 26 provides learning and control functions. An exemplary high-level flow for AI learning and control includes input from a data source 32 to an artificial neural network (ANN) 33. ANN 33 also receives information from an expert system 34 and outputs various decisions 35 affecting the operation of the system 1. The ANN 33 communicates with sub-systems control unit 36, which may include modules relating to various functionalities such as a transactions module 37, funds control/management 44, and blockchain and NFT module 46.

The system also offers blockchain support and NFT support. Blockchain enables the existence of both cryptocurrencies and NFTs, which exist on blockchain data, a distributed public ledger that records transactions. As known in the art, a blockchain is a decentralized ledger of all transactions across a peer-to-peer (P2P) network, created when two or more personal computers are connected and share resources without going through a separate server. Using blockchain technology, users can confirm transactions without a need for a central clearing authority. NFTs typically are held on the Ethereum blockchain, although other blockchains support them as well.

As mentioned above, blockchain uses a decentralized, or distributed, ledger that exists on a host of independent computers, often called nodes, to track, announce, and coordinate synchronized transactions. The system's blockchain 40 is a series of data “blocks” that are linked together. This chain of blocks creates a shared digital ledger (collection of data) that records the activity and information within the chain. Each node or block in the decentralized blockchain constantly organizes new data into blocks, and chains them together in an “append only” mode. This append-only structure is an important part of blockchain security. No one on any node can alter or delete the data on earlier blocks; they can only add to the chain. That the chain can only be added to is one of the core security features of blockchain.

Each blockchain ledger is stored globally across the system's users only. This means that only users of the system 1 are on the network and can see (and verify) everyone else's artwork postings. It is a closed, private network, so only the system's users have access to the system blockchain 40. That is how the system 1 can control internal data and restrict outsiders from joining. By referring to the chain, participants (system users only) can present, and confirm transactions. This cuts out the need for a central clearing authority. This peer-to-peer and distributed ledger technology makes it nearly impossible to falsify or tamper with data within a block and is governed by an artificial intelligence (AI) unit 26, as discussed in more detail herein.

In exemplary embodiments, an NFT 28 is created or “minted” when a work of art 14 receives a certain number of pre-detrainment likes 20. Minting an NFT 28 means making a digital work of art 14 part of a blockchain. NFTs 28 are built using the same kind of programming as cryptocurrencies. However, unlike fungible cryptocurrencies, NFTs 28 are non-fungible, i.e., each has a digital signature that makes it impossible for it to be exchanged for or equal to one another. The digital work of art 14 is represented as an NFT 28 so it can be purchased and traded in the digital auction system 22 and digitally tracked as it is resold or collected again in the future. An NFT 28 can be minted from digital objects that represent both tangible and intangible items, including but not limited to art, GIFs, videos, sports highlights, collectibles, virtual avatars, video game skins, designer sneakers, and music.

NFTs 28 are like physical collector's items, but digital. Instead of getting the actual work of art 14, the buyer receives a digital file instead along with an exclusive ownership right to the digital file. An NFT 28 can have only one owner at a time. An NFT's unique data make it easy to verify ownership and transfer between owners. The owner or creator of an NFT 28 can store specific information inside it. For instance, an artist can sign his work of art by including his signature in an NFT's metadata.

Exemplary embodiments of the system 1 include an artificial intelligence (AI) unit 26. In some ways, AI technology is the centerpiece of the system 1. In exemplary embodiments, it controls the security and blockchain operations, items' likes, funding, and transactions. In addition, it may be used to supervise NFT creation, handling, and transactions. It may be connected to NFT sites to publish NFTs and handle bids and transactions.

As discussed in more detail herein, the AI unit 26 performs the data encryption and blockchain processing. The machine learning feature of the AI unit 26 enables many functions from security to marketing. Perhaps most important is its cybersecurity functions. The AI unit's 26 security functionality provides a robust infrastructure including unique processes to supervise cybersecurity, privacy, and overall system management. This includes user accounts, internal communication channels, and posting methods, among other things. It identifies users according to their biometric and/or facial features and grants access to the platform based on their positive identification. The AI unit 26 regularly encrypts and decrypts all the network's data and constantly monitors for hacking and other security breaches. If it detects a breach, the AI unit 26 blocks the intruding channel along with all its associates and alerts the system's administrator.

The AI unit 26 secures all transactions by users on the system 1. The system 1 manages users' digital wallets, which can be used to store NFTs 28 and cryptocurrencies and user's purchased cryptocurrencies. It secures the cryptocurrency purchasing using credit cards, PayPal and similar. In exemplary embodiments, users' credit card information is protected by AES 256 bit security. The system works with NFT platforms that create and offer NFTs, e.g., OpenSea.io, Radiable, Foundation, and controls transactions with these systems.

The AI unit 26 manages the blockchain technology. It makes units of data and stores them on a blockchain digital ledger 40, creating NFTs securely. Each NFT 28 acts as a kind of certificate of authenticity, showing that a digital asset is unique and not interchangeable. The created NFT 28 can never be changed or adjusted, and is protected from being stolen because of its cryptographic data, which make the blockchain 40 unique. The AI unit 26 includes a cryptography engine that encrypts the data using an RSA cryptosystem.

In exemplary embodiments, the AI unit 26 secures system data by using private asymmetric encryption methods and the secure nature of transactions on the blockchain 40. Encryption refers to technical processes of converting plaintext into ciphertext and back again, which secure data and systems, making it difficult for unauthorized parties to gain access to encrypted information. In symmetric key systems, the same key is used for encrypting and decrypting data. In asymmetric or public key systems, the encryption key is publicly available, but only the authorized holder of the private decryption key can gain access to the decoded plaintext.

In exemplary asymmetric encryption, users are assigned private keys to verify that they are owners of their NFTs 28. The transactions are secured with hashing and blockchain encryption techniques. The AI system 26 secures the blockchain records through cryptography. Network participants have their own private keys that are assigned to the transactions they make and act as a personal digital signature. If a record is altered, the signature will become invalid, and the peer network will know right away that something has happened. The AI system 26 performs constant scans for abnormalities of this type and provides an early notification and stops the transaction to preventing further damage.

Because blockchains are not contained in a central location, they don't have a single point of failure and cannot be changed from a single computer. It would require massive amounts of computing power to access every instance of a certain blockchain and alter them all at the same time. Yet, in exemplary systems, the AI unit 26 keeps track of all transactions in a segmented approach for extra security. Each user's transactions are stored on a central database that is segmented and split over many nodes. In this way its virtually un-hackable to breach the system.

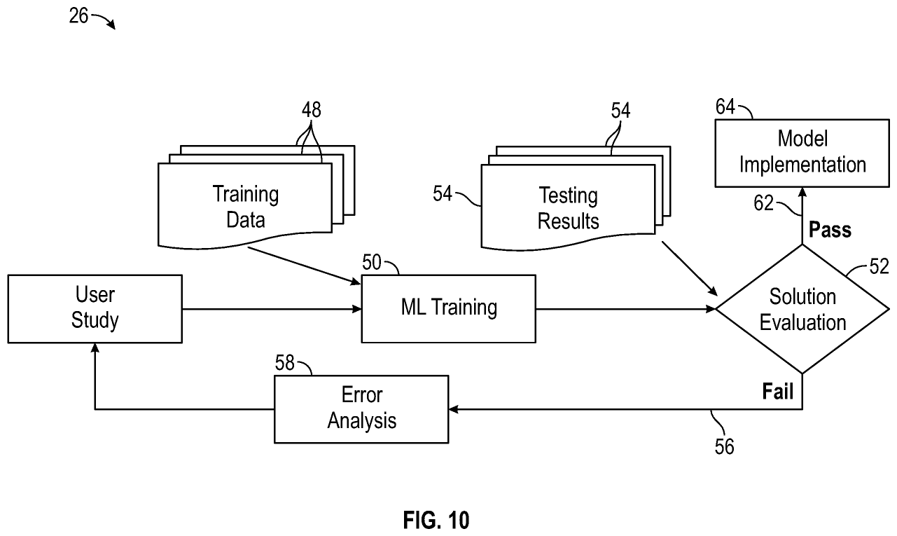

An exemplary flow for the AI unit 26 is shown in FIG. 10, where training data 48 is fed into the AI system 26 for machine learning training 50. The solution provided by the AI unit 26 is evaluated 52, aided by the input of testing results 54. If the solution fails 56, an error analysis 58 is performed, followed by a user study 60, the results of which may be utilized for another round of machine learning training 50. If the solution passes evaluation 62, then the AI unit 26 proceeds to model implementation 64.

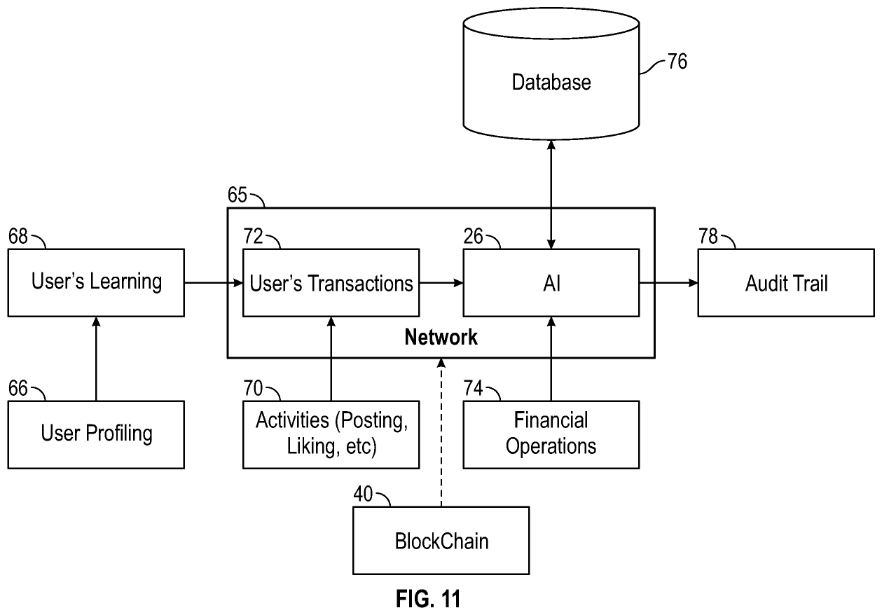

The AI system 26 can perform supervised learning and/or unsupervised learning. An exemplary supervised learning approach is illustrated in FIG. 11. This approach uses labeled data for learning and predicting outcomes. More particularly, several labeled data inputs are provided to the AI system 26 for learning, some from inside the network 65, some from outside. These could include user profiling data 66 and the users' learning 68. Data relating to activities 70, e.g., posting, liking, etc. may also be used. User transaction 72 and financial operation 74 data are also utilized by the AI unit 26. The AI unit 26 is in communication with a database 76 that stores the relevant system data, and the output of supervised learning may include an audit trail 78.

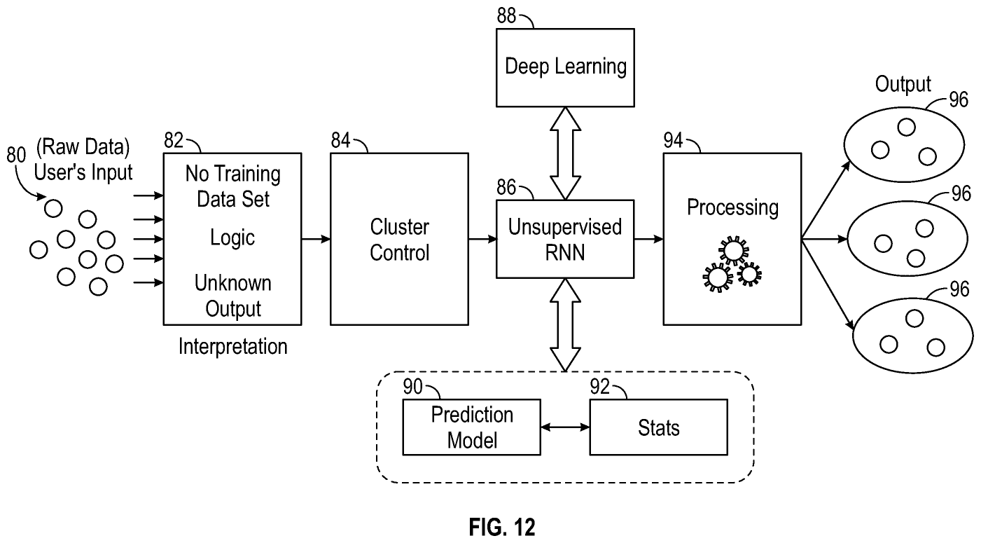

FIG. 12 shows an exemplary flow for unsupervised learning by the AI unit 26. In this case, the data typically is raw, and a training set may not be provided to the AI unit 26. The user's input 80 here is raw data, which is fed into the logic system 82. It should be noted that there is no training data set for the logic system 82, and the output is unknown. The next step in the unsupervised learning is cluster control 84. Clustering is dividing the data into groups based on their similarities or differences. The data may then be passed on to an unsupervised recurrent neural network (RNN) 86, whose processes can power deep learning 88 and a prediction model 90 with relevant statistics 92. Finally, one or more layers of processing units (shown here for simplicity as processor 94) aid in learning from the data and provide various outputs 96.

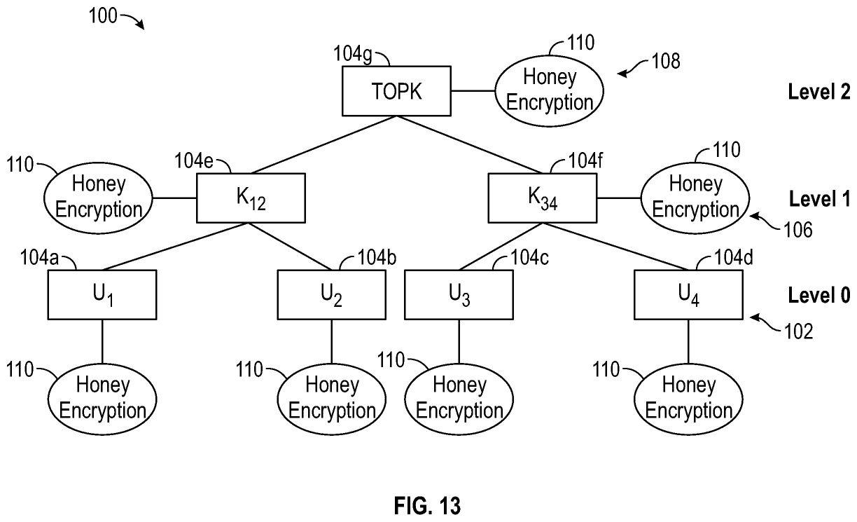

Referring to FIG. 13, in exemplary embodiments the AI unit 26 provides a Group Key Management (GKM) approach 100 for blockchain technology to achieve maximum, efficient security and confidentiality of records over the blockchain network. The blockchain security is done by the GKM framework 100. In this type of framework transactions are open only to participant members of the concerned group as well as for members of the parent group, but for non-members, transactions are confidential. This framework contains all the benefits of blockchain technology and increases restriction and security against intruders and non-members.

Multi-layered architecture is used within the AI unit 26 in which nodes of the upper level have more privileges and rights than the nodes of the lower level. At each level, there are multiple groups, and each group contains multiple nodes. Nodes belonging to the same group have the same privileges. At the lower level (level 0) 102, nodes 104a-104d join the group with the consent of nodes 104e, 104f of the parent group at the middle level (level 1) 106. Within each group a dedicated AES encryption is performed and within each of the multiple levels the system implements a Honey encryption 110 method to provide additional security in case of a hacking attempt. FIG. 13 shows TOPK node 104g as the TOP level layer 108 as the Kx,x 106 are lower levels, and Ux 102 are the lowest levels.

An exemplary GKM system 100 works as follows. Parent groups have higher privileges, and they can view the confidential data of the child groups. No group can access confidential data of the parent groups and groups which are at the same level. To manage the GKM network, the root group assigns the GKs to the groups which are at level 0 with the consensus of members of the root group. In case of any membership change for any group, the root group updates the concerned group keys with the consensus of the members of the root group.

At level 0, Group Keys are assigned to each U group. Group Keys of groups of higher layers (1 and 2) are computed using the group keys of child groups using the unidirectional function. A unidirectional cryptographic function generates the output of a cipher key length. An AI algorithm manages the GKM network groups and assignments. The AI unit also updates each group's keys in case of any membership change for any group. The additional layer of Honey encryption module 110 adds another level of security so even in the unlikely event of a data breach the intruder will receive millions of possible keys, and all will look viable when in fact they are not. In this way the system 100 deceives intruders about which key is the real one, and the system benefits from a very high level of security. In this method and system all application transactions are available to all members of the concerned group as well as for members of the parent group, but for not for non-member transactions. In this way all blockchain data transactions are secured.

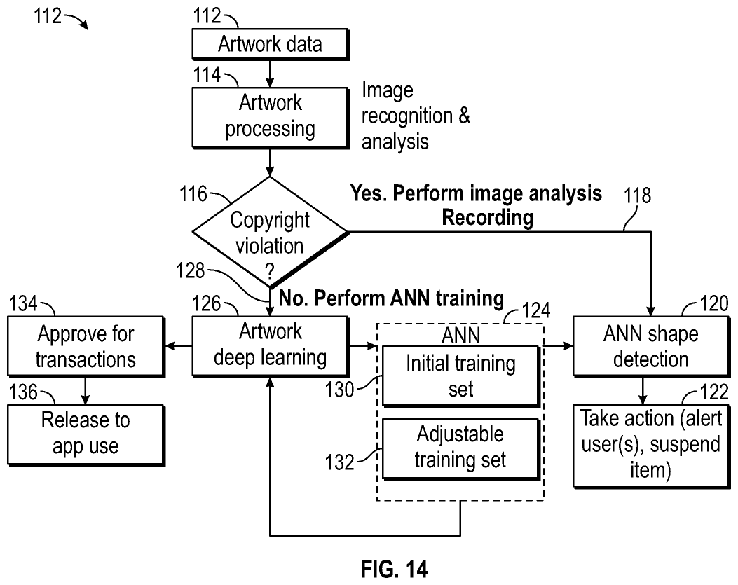

The AI unit 26 provides another form of security through image recognition processes. For instance, it learns all the features of each digital work of art posted 14 and “polices” the platform to ensure copyright protection. If it detects unauthorized copying of a work of art 14, the AI unit alerts the owner of the work of the copyright violation. An exemplary copyright detection system 112 is shown in FIG. 14. Artwork data 114 is fed into an artwork processor 114 for image recognition and analysis. The system 1 queries whether a copyright violation has occurred. If the answer is yes, an image analysis 118 and shape detection 120 are performed. In exemplary embodiments, an artificial neural network (ANN) 124 is provided for shape detection. In the event of copyright infringement, the system will take action 122 such as alerting the affected user or users and/or suspending the infringing work.

If there is no copyright violation, then ANN training is performed 128. This includes deep learning 126 of the artwork. An exemplary ANN 124 has an initial training set 130 of data as well as an adjustable training set 132. When a work of art does not violate a copyright, it will be approved 134 for transactions and released 136 for use on the platform.

Advantageously, the AI unit 26 also enhances user experience and helps with marketing. It could monitor each user's personal art and points/tokens vault, and according to the user's record, offer coin purchase credit. The AI unit 26 also could learn a user's selling/buying pattern and suggest posted artwork to buy/sell. Upon a user's request, it can launch a marketing campaign according to the artwork genre and characteristics. In this scenario, the AI unit 26 studies the artwork field and publishes marketing campaigns in instaFame and other social media networks like Facebook, Instagram, and Twitter. It might also track a work of art's geographical location and recommend presenting it in tradeshows/conferences in the appropriate geographic location according to its genre.

As it learns the genres of the posted works of art, the AI unit 26 may suggest an AI-made version of a user's art. The AI unit 26 could analyze the artwork and create digital versions of the work of art 14 in several different genres (Humoristic, Gothic, Modern, Cartoon, etc.). The user would be able to choose any of the additional genre versions of her work of art or as an additional item or a personal item. In exemplary embodiments, the AI unit 26 tracks a work of art's history, creating an ancestry tree with all the work's records since its inception. It can also assist with parental control by analyzing each posted work of art 14 to identify its genre/characteristics and attach PG, R, or other ratings to the work and/or issue warnings about content which is inappropriate for children.

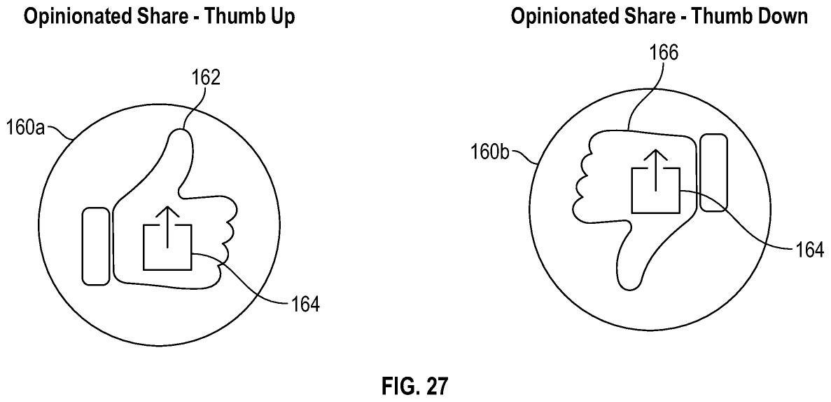

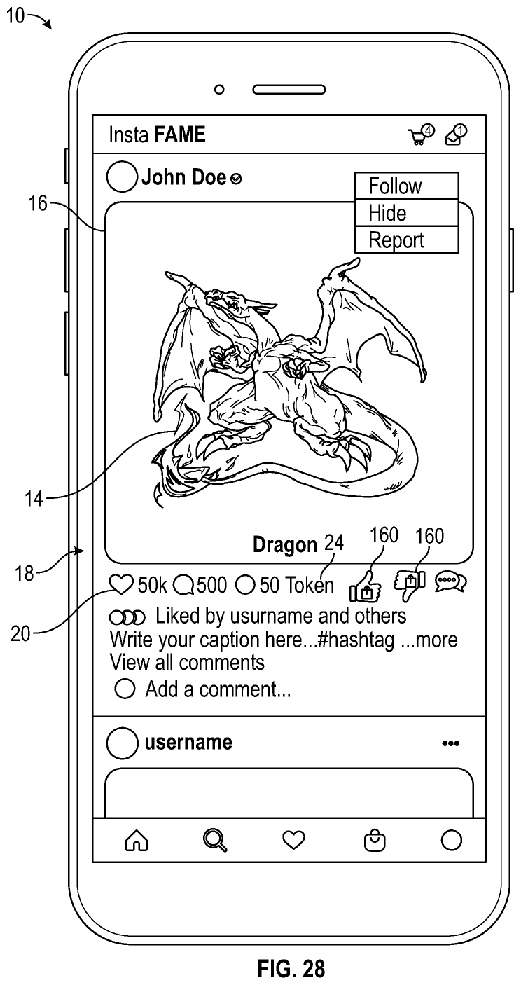

Turning to FIGS. 27 and 28, exemplary embodiments feature an opinionated share button 160. This is like a share touch button, but different from existing applications in that this one is an opiniated share, i.e., the share feature and like or dislike features are combined into one button. Advantageously, by using this one-touch opinionated share button 160, when a user shares a work of art, post, article, picture, video, or any other content, he or she can express their opinion whether they like or dislike the content quickly and efficiently with the share.

An exemplary one-touch like-share button 160a is a thumb's up button or icon 162 with a share icon 164 inside it. A one-touch dislike-share button 160b is a thumb's down button or icon 166 with a share icon 164 inside it. Variations are possible, such as positioning the thumb's up icon 162 and thumb's down icon 166 inside, next to, above, or below the share icon 164, and other variations are possible, so long as the share and the like or dislike are combined into one combination opinionated share button 160. Different colors could be used for each button to correspond to the like or dislike, e.g., blue or green for like-share button 160a and red for the dislike-share button 160b.

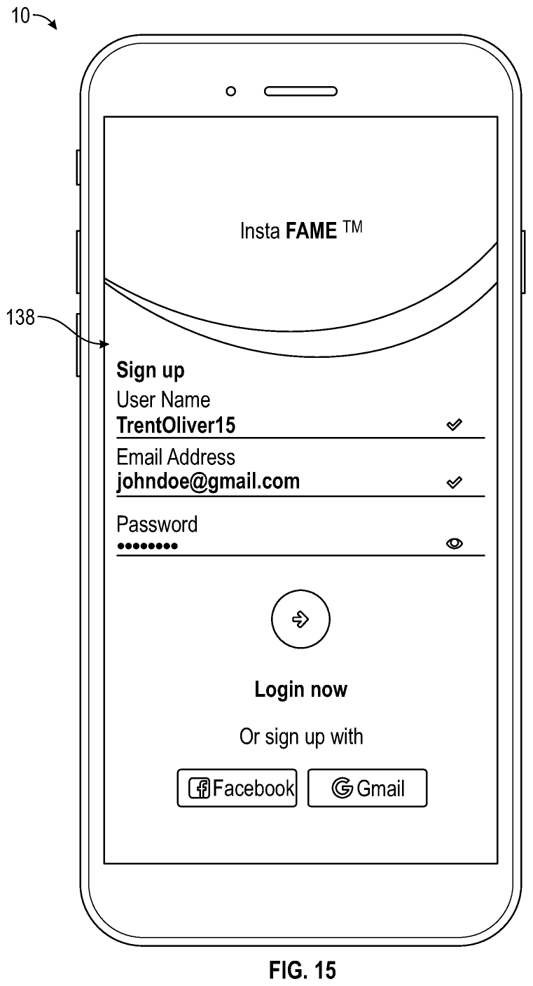

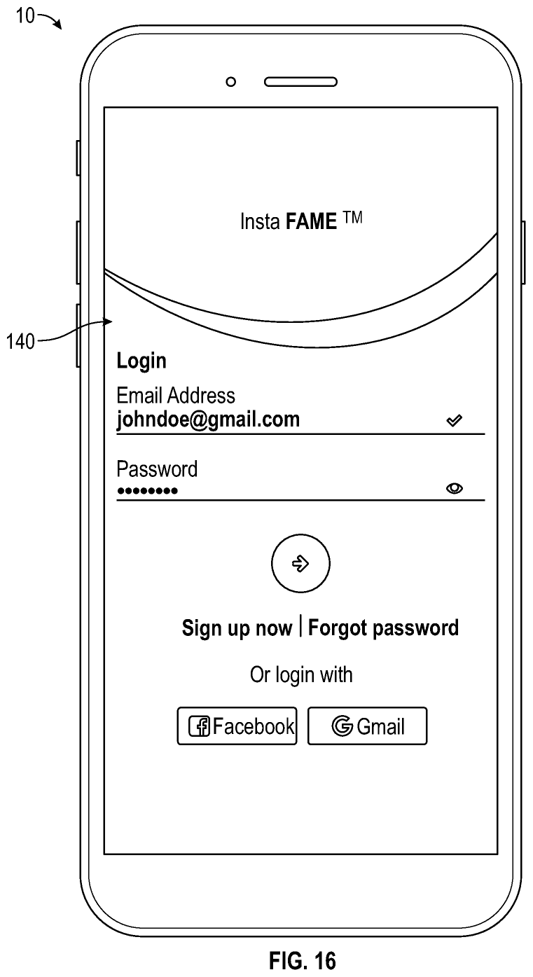

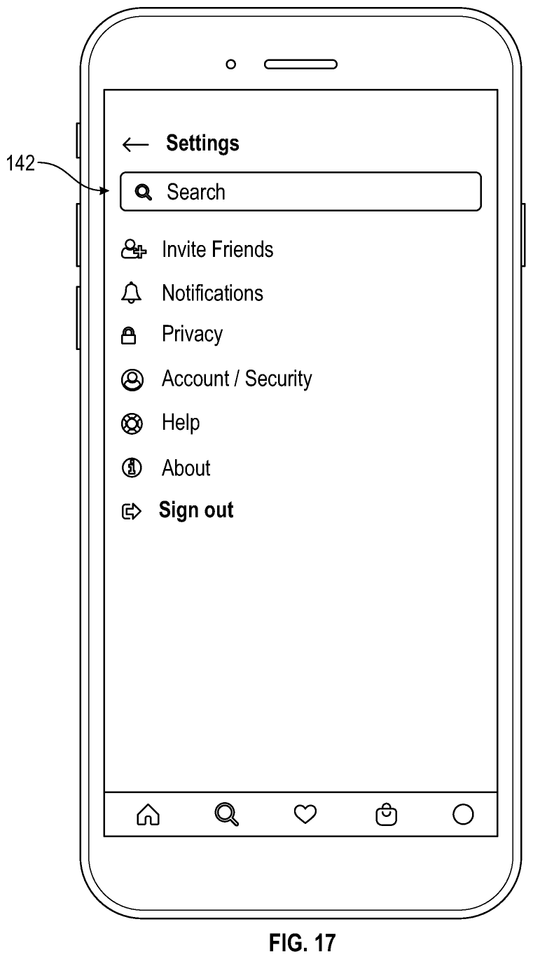

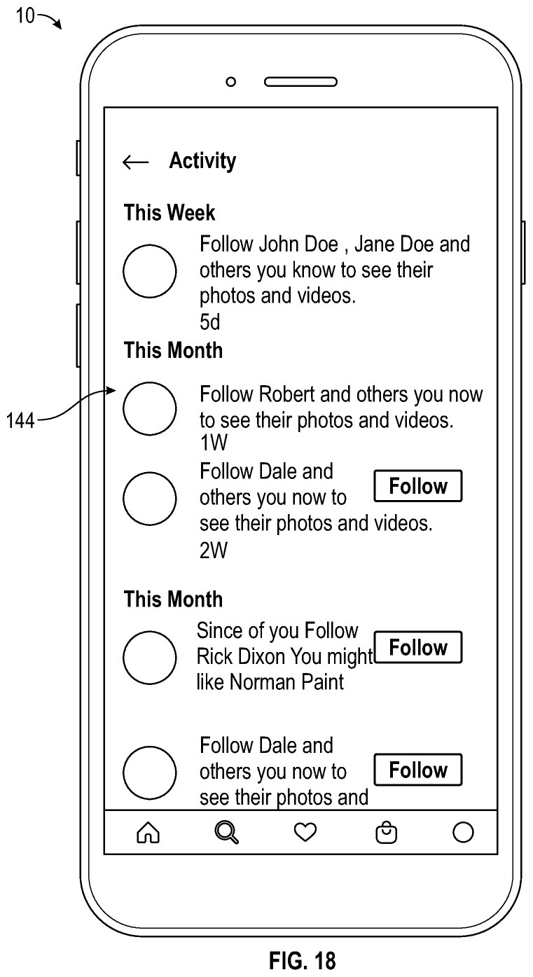

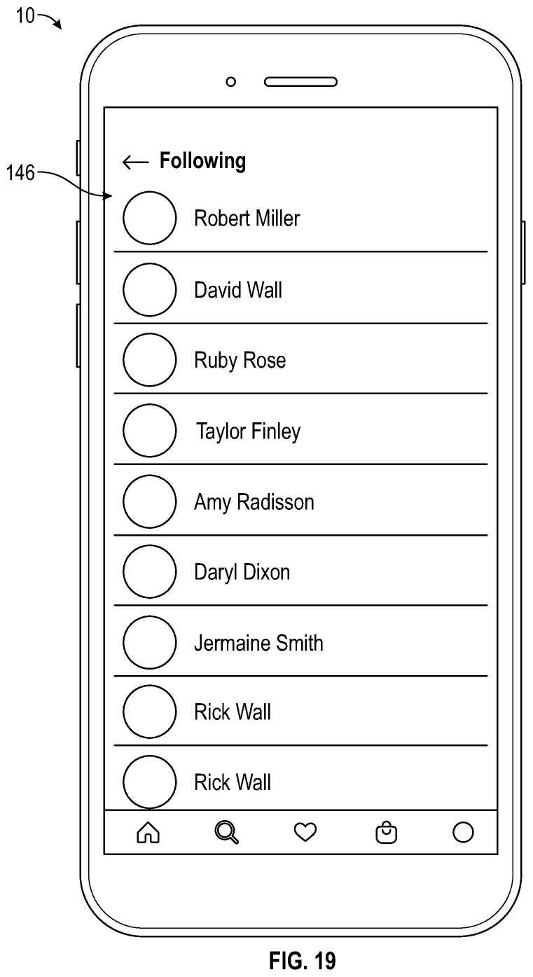

In operation, the system 1 may be open to the public, or a user might need to get a reference from a current member to join. Referring to FIGS. 15 and 16, a new user registers with the system 1 through the sign-up page 138 of the graphical user interface and creates his or her security credentials such as username, password, and biometric and/or facial features for access to the platform. The system then displays a login page 140. The system may prompt the user to enter his credit card information for purchasing points/tokens. The settings page 142 (FIG. 17) of the graphical user interface allows the user to adjust various settings, such as notifications, privacy, and account/security settings. An activity page 144 (FIG. 18) tracks the recent activity on the platform and suggests other users to follow, while the following page 146 (FIG. 19) lists who the user is following.

Once registered and logged in, the new user can now create and upload digital works of art 14 to his or personal page 12. If the user uploads a digital work of art 14 to his personal page 12, he can receive likes 20 for that work from other users. If another user offers the purchase price, the seller-user will receive the payment, and the buyer-user will get the work of art 14 and all its associated likes transferred to his personal page. As discussed above, the purchase price is the product of the monetary value assigned to each like 20 for that work of art 14 multiplied by the number of likes 20 posted for the work of art 14.

The user also can browse works of art 14 displayed on the pages of other users. If she finds a posted work of art 14 that appeals to her, she can post a like 20 for that work of art. To buy a work of art 14, the user offers the purchase price to the owner of the artwork post. As discussed above, she uses points/tokens to buy a work of art, and these can be purchased by her accumulated likes. She could also use a credit card to buy points/tokens from the administrator. As discussed above, the platform's auction module 22 will then transfer payment to the owner of the work of art 14 and transfer the posted work of art 14 and all its associated likes 20 to the buyer-user. If the buyer-user re-sells the work of art 14, the original owner-creator of that work of art will receive a royalty payment on that subsequent sale.

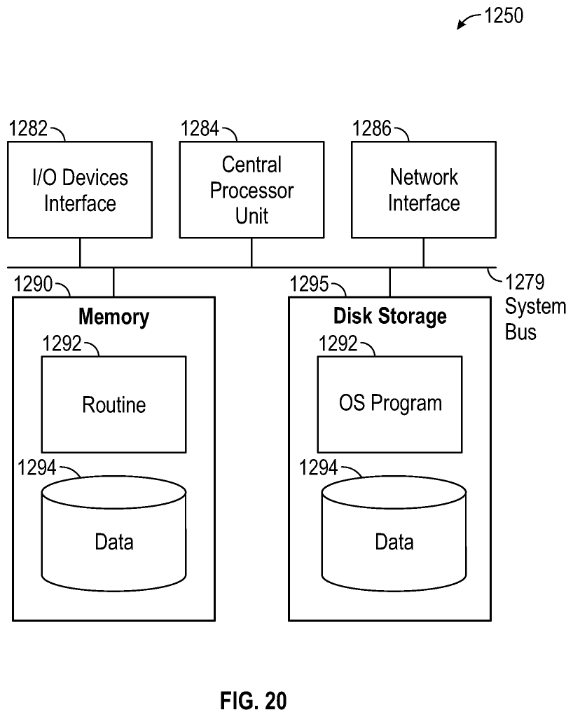

FIG. 20 shows an exemplary internal structure of a computer 1250 in which various embodiments of the present disclosure may be implemented. The computer 1250 contains a system bus 1279, where a bus is a set of hardware lines used for data transfer among the components of a computer or processing system. Bus 1279 is essentially a shared conduit that connects different elements of a computer system (e.g., processor, disk storage, memory, input/output ports, network ports, etc.) that enables the transfer of information between the elements. Attached to system bus 1279 is I/O device interface 1282 for connecting various input and output devices (e.g., sensors, transducers, keyboard, mouse, displays, printers, speakers, etc.) to the computer 1250. Network interface 1286 allows the computer 1250 to connect to various other devices attached to a network.

Memory 1090 provides volatile storage for computer software instructions 1292 (e.g., instructions for the processes/calculations described above and data 1294 used to implement embodiments of the present disclosure). Disk storage 1295 provides non-volatile storage for computer software instructions 1292 and data 1294 used to implement embodiments of the present disclosure. Central processor unit 1284 also is attached to system bus 1279 and provides for the execution of computer instructions.

In an exemplary embodiment, the processor routines 1292 (e.g., instructions for the processes/calculations described above) and data 1094 are a computer program product (generally referenced 1292), including a computer readable medium (e.g., a removable storage medium such as one or more DVD-ROMs, CD-ROMs, diskettes, tapes, etc.) that provides at least a portion of the software instructions for exemplary embodiments. Computer program product 1292 can be installed by any suitable software installation procedure, as is well known in the art.

In another embodiment, at least a portion of the software instructions may also be downloaded over a cable, communication and/or wireless connection. Further, the present embodiments may be implemented in a variety of computer architectures. The computer of FIG. 20 is for purposes of illustration and not limitation. In some embodiments of the present disclosure, the system may function as a computer to perform aspects of the present disclosure.

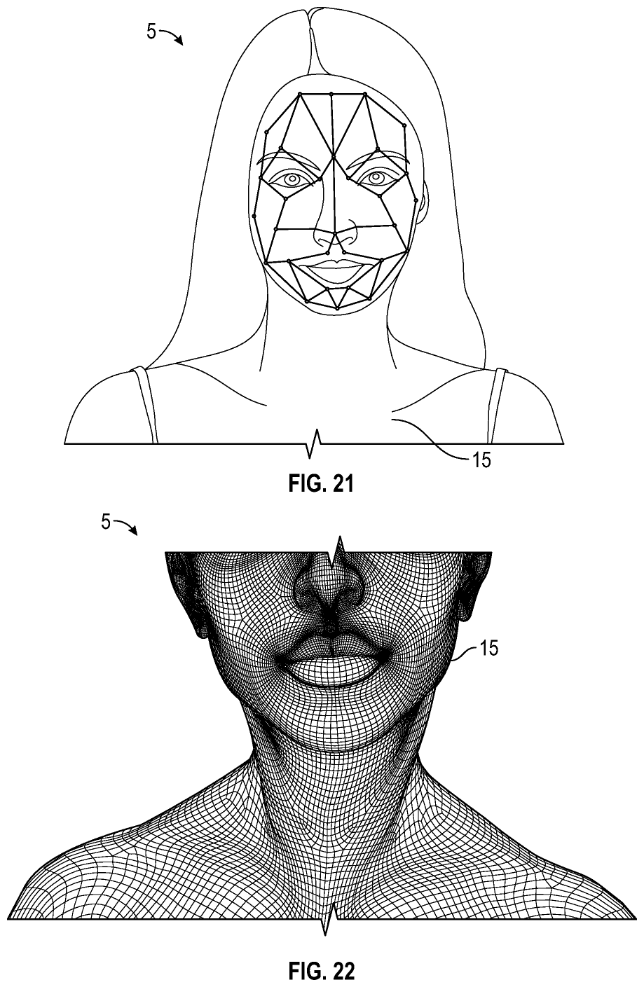

Because the system 1 and related digital auction system 22 involve display of artwork, exemplary embodiments provide intelligent solutions for supervising its content. One such solution is automatic scanning of posted works of art 14 to identify extreme cases of inappropriate content. Thus, exemplary embodiments perform image processing 5 to identify inappropriate posts and remove them in real time. As shown in FIGS. 21 and 22, pattern recognition processes may be incorporated to distinguish and classify objects in an image 15, identify their positions, and understand their meaning and overall scene. More particularly, a pattern recognition-based AI process may be provided to scan for images or videos that contain inappropriate material 240 such as violence, racism, sexual content, etc. When these types of materials are detected, the system immediately removes the offensive posted work of art 14. Exemplary embodiments may include a “Report” option 151 to enable users to provide feedback about an inappropriate post.

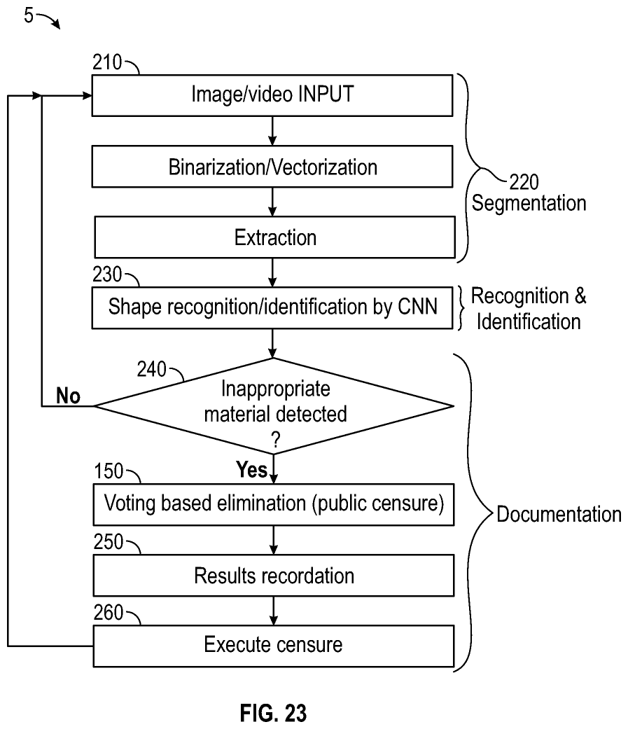

An exemplary image processing 5 flow is illustrated in FIG. 23. First, the system 1 performs image acquisition or input 210 to capture an image 15 from the picture or video. The next step is to perform image morphological processing for shape recognition 230 to describe the shapes and structures of the objects within the image. The AI-based image recognition uses object detection and recognition techniques. Exemplary embodiments also use morphological processing techniques to create datasets to train the AI model to identify and detect what type of information needs to be censured. The system may use convolutional neural networks for the task of semantic image segmentation 220, which may include binarization/vectorization and extraction, to label specific regions of an image, identifying what is in this image and where in the image it is located. Ultimately, the system performs image recognition to identifying specific features of objects within images/videos. The system may record 250 the results.

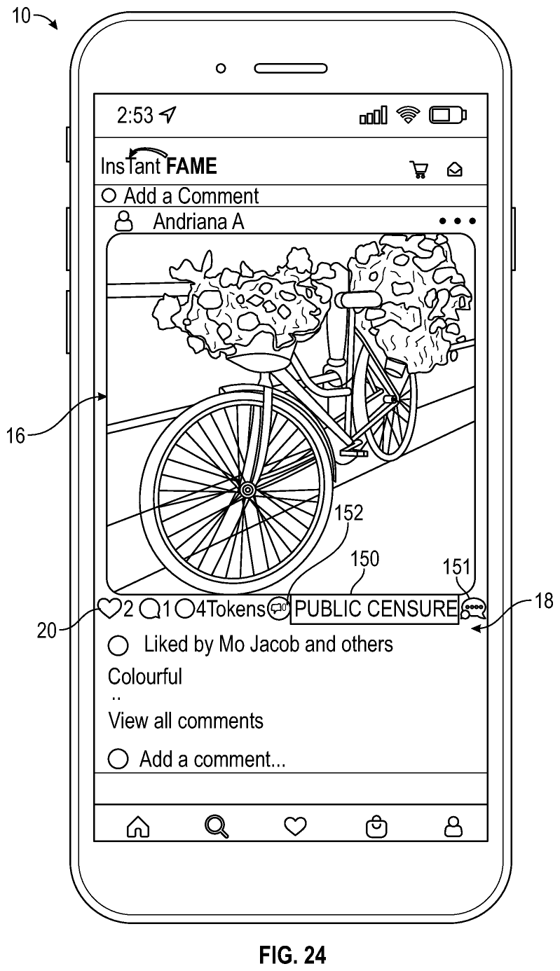

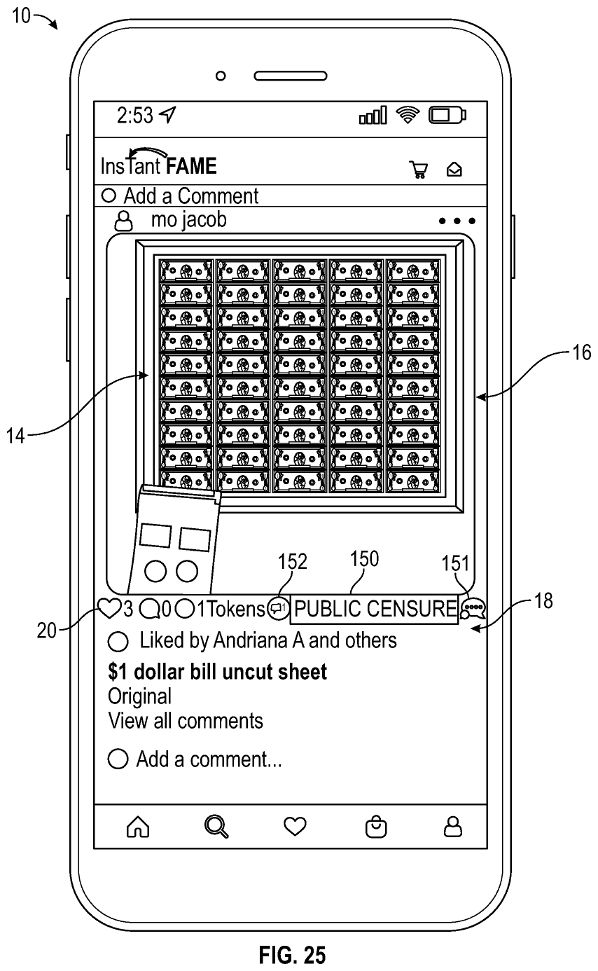

Exemplary embodiments include a public censure system 150 that enables deletion of a work of art 14 should it be deemed inappropriate or offensive. As illustrated in FIGS. 24 and 25, an exemplary public censure system 150 works as follows. In addition to the likes 20 discussed above, each posted work of art 14 has the option of a dislike 152, for example, a “thumbs down.” If a user posts an inappropriate image or video and receives a dislike 152 from more than a pre-determined percentage of the viewers of the work of art 14, then the system executes 260 censure, and the posted work of art is automatically removed from the system 1. This is called public censure. In exemplary embodiments, the pre-determined percentage is two percent (2%), but this could vary depending on various factors.

In addition to the mechanism based on percentage of dislikes 152, the public censure system 152 may include a supervisory system 154 and run neural network (AI) processes that watch over a posted work of art's dislike/thumb's down content over time. Once a dislike 152 is initiated in connection with a posted work of art 14, the post automatically goes to the supervisory system 154, which begins to monitor the post. The supervisory system 154 constantly monitors the posted work of art 14, its related comments, text exchanges, and crowd reactions, to ensure that all the communications and feedback remain appropriate and non-offensive, a function which may be assisted or run by the AI unit 26. Should it detect inappropriate or offensive content or communication along with the posted work of art 14 (e.g., violence, racism, sexual content, etc.), the post and/or its communications, feedback, and/or comments are immediately removed and the user who posted the work of art is notified.

In exemplary embodiments, the public censure system 150 performs natural language processing (NLP) techniques and text classification processes to identify inappropriate or offensive content. More particularly, this intelligent aspect of the public censure feature involves NLP and novel text classification processes for organizing large amounts of unstructured text by providing meaning to the raw text data received from the users of the system, identifying inappropriate or offensive content, and eliminating it in real time. Exemplary classification processes include topic modeling, sentiment analysis, and keyword extraction to extract the most relevant information from users' texts using AI and machine learning.

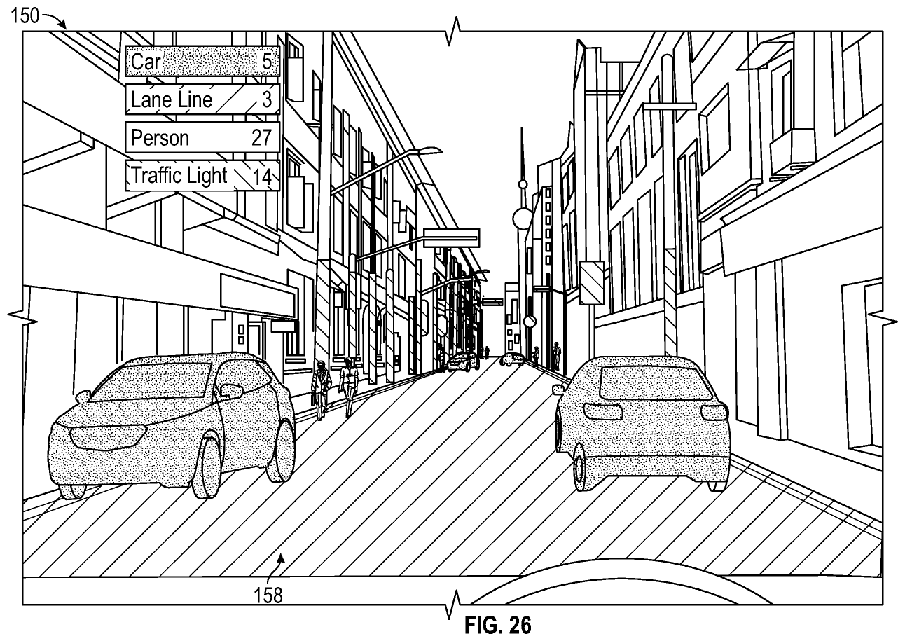

As shown in FIG. 26, another intelligent feature of the public censure system 150 is the use of a convolutional neural network (CNN) 156 performing semantic image segmentation 158 to identify inappropriate or offensive content. The CNN may be used for the task of semantic image segmentation, identifying inappropriate materials that are posted as images and/or videos on the system platform. In exemplary embodiments, the image segmentation is a computer vision process that labels specific regions of an image or video, classifying it according to its content and identifying its nature. The public censure system 150 can identify single objects and multiple objects, classifying the objects and reaching conclusions about their nature.

Thus, it is seen that digital auctions and systems and methods for digital ratings and secured sales of digital works of art are provided. It should be understood that any of the foregoing configurations and specialized components or connections may be interchangeably used with any of the systems of the preceding embodiments. Although illustrative embodiments are described hereinabove, it will be evident to one skilled in the art that various changes and modifications may be made therein without departing from the scope of the disclosure. It is intended in the appended claims to cover all such changes and modifications that fall within the true spirit and scope of the present disclosure.

What is claimed is:

1. A computer-implemented blockchain system for digital ratings and secured sales of digital works of art, comprising:
a platform enabling a first artist to post a first digital work of art on the first artist's personal page;
an interface enabling users to become followers of the first digital work of art and post a like for the first digital work of art, the platform assigning a monetary value to the like, the interface including at least one opinionated share button; and
an auction module enabling users to bid on the first digital work of art;
wherein the first digital work of art is assigned a purchase price equal to the monetary value assigned to the like multiplied by a number of likes for the first digital work of art; and
wherein when a user offers the purchase price the auction module transfers payment to the first artist and the first work of art to the user.

2. The system of claim 1 wherein the at least one opinionated share button comprises a combination like-share button and a combination dislike-share button.

3. The system of claim 2 wherein the combination like-share button includes a thumb's up icon.

4. The system of claim 2 wherein the combination dislike-share button includes a thumb's down icon.

5. The system of claim 1 wherein works of art can be purchased via likes.

6. The system of claim 5 wherein the first artist can redeem the likes posted for the first digital work of art to purchase a second digital work of art owned by a user or a second artist.

7. The system of claim 5 wherein a user who purchases the first digital work of art can redeem the likes posted for the first digital work of art to purchase a second digital work of art owned by another user or the first artist or a second artist.

8. The system of claim 1 wherein when the user purchases the first digital work of art it is transferred from the first artist's personal page to the user's personal page.

9. The system of claim 8 wherein the followers and likes associated with the first digital work of art are transferred from the first artist's personal page to the user's personal page.

10. The system of claim 1 wherein if a digital work of art receives a pre-determined number of likes it is transformed into a non-fungible token.

11. The system of claim 1 wherein all payments are stored in a blockchain.

12. A digital auction system using blockchain-secured digital tokens, comprising:
a platform enabling a first artist to post a first digital work of art on the first artist's personal page;
an interface enabling users to become followers of the first digital work of art and post a like for the first digital work of art, the platform assigning a monetary value to the like, the interface including a combination like-share button and a combination dislike-share button;
an auction module enabling users to bid on the first digital work of art; and
an artificial intelligence unit learning features of the first digital work of art;
wherein the first digital work of art is assigned a purchase price equal to the monetary value assigned to the like multiplied by a number of likes for the first digital work of art;
wherein when a user offers the purchase price the auction module transfers payment to the first artist and the first work of art to the user;
wherein works of art can be purchased via likes or via digital tokens that can be redeemed for cash; and
wherein when a user purchases the first digital work of art, followers associated with the first work of art and likes associated with the first digital work of art are transferred from the first artist's personal page to the user's personal page.

13. The digital auction system of claim 12 wherein the combination like-share button comprises a thumb's up icon and a share icon inside the thumb's up icon.

14. The digital auction system of claim 12 wherein the combination dislike-share button comprises a thumb's down icon and a share icon inside the thumb's down icon.

15. The digital auction system of claim 12 wherein the combination like-share button and the combination dislike-share button are color-coded.
